(19) United States
(12) Patent Application Publication
(10) Pub. No.: US 2024/0241874 A1
(43) Pub. Date: Jul. 18, 2024

(54) DISSEMINATING CONFIGURATION ACROSS DISTRIBUTED SYSTEMS USING DATABASE NODES

(71) Applicant: VMware, LLC, Palo Alto, CA (US)

(72) Inventors: Ziyou WANG, Beijing (CN); Donghai HAN, Beijing (CN)

(21) Appl. No.: 18/312,701

(22) Filed: May 5, 2023

(30) Foreign Application Priority Data
Jan. 18, 2023 (WO) PCT/CN2023/000014

(51) Int. Cl. G06F 16/22

(52) U.S. Cl. CPC G06F 16/2272; G06F 16/2246

(57) ABSTRACT

Certain embodiments described herein are generally directed to techniques for distributing configuration information in a network. Embodiments include receiving, by a database node running on a computing device, from a parent component, configuration information with respect to one or more logical entities and span information indicating one or more respective host computers related to each of the one or more logical entities. Embodiments include determining a first subset of the configuration information and a first subset of the span information to provide to a first child database node based on a first set of host computers associated with the first child database node. Embodiments include determining a second subset of the configuration information and a second subset of the span information to provide to a second child database node based on a second set of host computers associated with the second child database node.

### CROSS-REFERENCE TO RELATED APPLICATIONS

This application claims priority to International Patent Application No. PCT/CN/2023/000014, filed Jan. 18, 2023, entitled “DISSEMINATING CONFIGURATION ACROSS DISTRIBUTED SYSTEMS USING DATABASE NODES”, and assigned to the assignee hereof, the contents of which are hereby incorporated by reference in their entirety.

### BACKGROUND

Software defined networking (SDN) comprises a plurality of hosts in communication over a physical network infrastructure, each host having one or more virtualized endpoints such as VMs, containers, or other virtual computing instances (VCIs) that are connected to logical overlay networks that may span multiple hosts and are decoupled from the underlying physical network infrastructure. Though certain aspects are discussed herein with respect to VMs, it should be noted that they may similarly be applicable to other suitable VCIs. Furthermore, certain aspects discussed herein may similarly be applicable to physical machines. Some embodiments of the present disclosure may also be applicable to environments including both physical and virtual machines.

Any arbitrary set of VMs in a datacenter may be placed in communication across a logical Layer 2 network by connecting them to a logical switch. The logical switch is collectively implemented by at least one virtual switch on each host that has a VM connected to the logical switch. The virtual switch on each host operates as a managed edge switch implemented in software by the hypervisor on each host. Forwarding tables at the virtual switches instruct the host to encapsulate packets, using a tunnel endpoint (VTEP) for communication from a participating VM to another VM on the logical network but on a different (destination) host. The original packet from the VM is encapsulated at the VTEP with an outer IP header addressed to the destination host using a mapping of VM IP addresses to host IP addresses. At the destination host, a second VTEP decapsulates the packet and then directs the packet to the destination VM. Logical routers extend the logical network across subnets or other network boundaries using IP routing in the logical domain. The logical router is collectively implemented by at least one virtual router on each host or a subset of hosts. Each virtual router operates as a router implemented in software by the hypervisor on the hosts.

SDN generally involves the use of a management plane (MP) and a control plane (CP). The management plane is concerned with receiving network configuration input from an administrator or orchestration automation and generating desired state data that specifies how the logical network should be implemented in the physical infrastructure. The management plane may have access to a database application for storing the network configuration input. The control plane is concerned with determining the logical overlay network topology and maintaining information about network entities such as logical switches, logical routers, endpoints, etc. The logical topology information specifying the desired state of the network is translated by the control plane into network configuration data that is then communicated to network elements of each host. The network configuration data, for example, includes forwarding table entries to populate forwarding tables at virtual switch(es) provided by the hypervisor (i.e., virtualization software) deployed on each host. An example control plane logical network controller is described in U.S. Pat. No. 9,525,647 entitled “Network Control Apparatus and Method for Creating and Modifying Logical Switching Elements,” which is fully incorporated herein by reference.

SDN often uses network controllers to configure logical networks throughout a datacenter. As SDN becomes more prevalent and datacenters cater to more and more tenants, controllers are expected to perform more operations. For example, a network controller may manage a plurality of managed forwarding elements (MFEs) (e.g., virtual routers, virtual switches, VTEPs, virtual interfaces, etc., running on host machines, which are physical computing devices that support execution of virtual machines (VMs) or other virtualized computing instances) that implement one or more logical networks. The hosts may implement various logical entities (e.g., logical routers, logical switches, etc.) of each logical network. A particular logical entity may be implemented on a subset of the hosts managed by the controller. The controller may receive an update (e.g., change to the desired state) of the particular logical entity. Accordingly, the controller may need to determine the subset of hosts that implement the logical entity (i.e., the span of the logical entity) to send the update so the logical entity can be updated.

Existing solutions involve the control plane distributing an update directly to the hosts corresponding to the span of a logical entity to which the update relates, such as via local control planes on the hosts. However, these techniques can become inefficient when large amounts of network configuration updates need to be distributed, which may result in a significant amount of load on the control plane. While some implementations involve implementing the control plane in a distributed manner across a plurality of nodes in order to distribute load, these implementations are generally limited to a small number of redundant nodes due to the complexities involved in the logic of the control plane.

Accordingly, there is a need in the art for improved techniques of distributing configuration information from a central control plane to hosts in an SDN environment.

### BRIEF DESCRIPTION OF THE DRAWINGS

FIG. 1 is a block diagram of a computing environment in which embodiments of the present disclosure may be implemented.

FIG. 2 is a block diagram of a network control system related to distributing configuration information in a network.

FIG. 3 is a block diagram of another example related to distributing configuration information in a network.

FIG. 4 illustrates an example exchange of messages between components related to distributing configuration information in a network.

FIG. 5 illustrates example operations related to distributing configuration information in a network.

### DETAILED DESCRIPTION

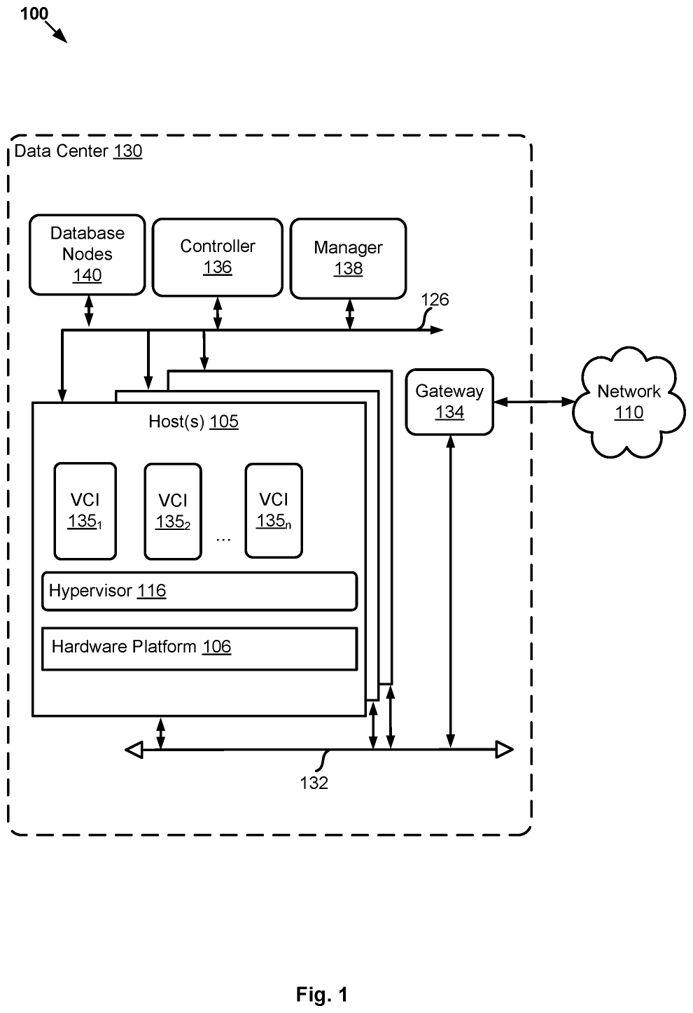

Embodiments presented herein relate to efficiently distributing configuration information in a network. In particular, a hierarchical database is used to efficiently distribute configuration information from a control plane to applicable hosts via a plurality of hierarchically organized database nodes. Each database node of the hierarchical database may store configuration information for a set of logical entities applicable to that database node along with span information for those logical entities as applicable to that database node. For example, a central control plane may receive a configuration change from a management plane (e.g., based on input from an administrator) and may determine a span of one or more logical entities to which the configuration change relates. As described in more detail below with respect to FIGS. 1-3, the central control plane may then send a configuration update along with the span information to a root database node of the hierarchical database. The root database node may then distribute a respective subset of the configuration information and respective span information to each respective child node of the root node in the hierarchical database based on which hosts or managed forwarding elements (MFEs) the child nodes are responsible for.

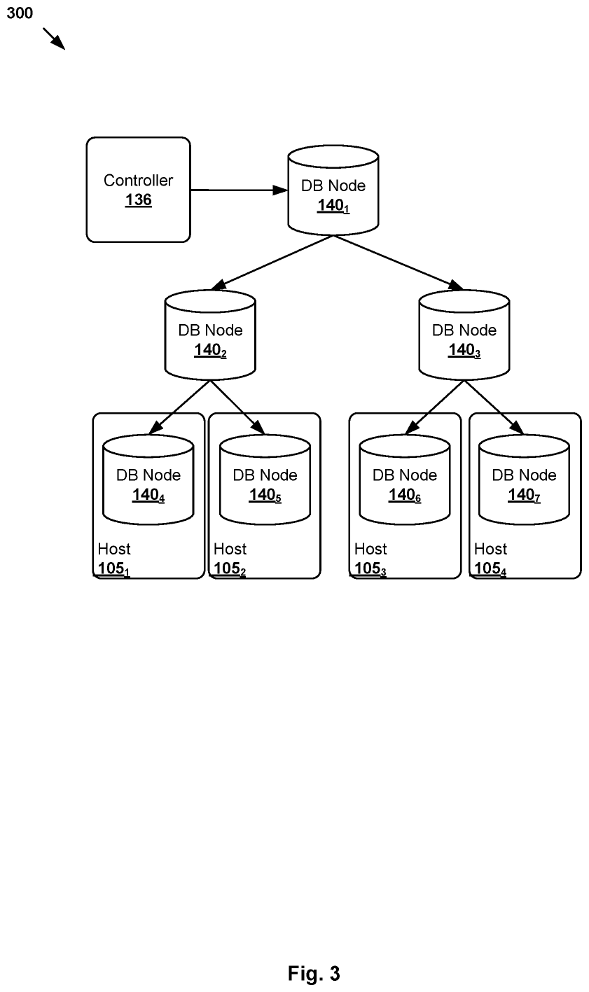

For example, as described in more detail below with respect to FIG. 3, each database node may, upon receiving a configuration update with associated span information, determine which child database nodes of the database node are associated with hosts that are indicated by the span information and then distribute a relevant subset of the configuration information and a relevant subset of the span information to each child database node accordingly. Hosts may have database nodes located thereon, and these database nodes on hosts may be the leaf nodes of a hierarchical tree of database nodes. Thus, configuration information and associated span information makes its way down the tree to the leaf nodes, where it is used on the hosts to update logical entities as appropriate.

Embodiments of the present disclosure improve the efficiency of distributing configuration information in a network, reduce load on the central control plane, and provide a simple, extensible solution that can be implemented independently of the management plane and central control plane in a networking environment. For example, by utilizing a hierarchical database comprising hierarchically organized database nodes that is separate from the control plane to perform distribution, techniques described herein allow the control plane to send all configuration updates to only a single entity (the root database node) regardless of how many hosts are included in the span of applicable logical entities, thereby offloading a significant amount of dissemination operations and logic from the control plane. Furthermore, the solutions described herein are scalable because database nodes can easily be added to the hierarchical database without affecting the control plane, and without requiring complicated logic to be implemented on either the control plane or the database nodes. Each database node needs only to compare span information in an update that it receives to known associations between child database nodes and hosts in order to select a subset of the update to send to each child database node. Thus, techniques described herein allow a computing environment to be improved through a conveniently implemented system that reduces load and improves the functioning of computing devices involved.

FIG. 1 depicts an example computing environment 100 comprising physical and virtual network components with which embodiments of the present disclosure may be implemented.

Computing environment 100 includes data center 130 connected to network 110. Network 110 is generally representative of a network of computing entities such as a local area network (“LAN”) or a wide area network (“WAN”), a network of networks, such as the Internet, or any connection over which data may be transmitted.

Data center 130 generally represents a set of networked computing entities, and may comprise a logical overlay network. Data center 130 includes host(s) 105, a gateway 134, a data network 132, which may be a Layer 3 network, and a management network 126. Data network 132 and management network 126 may be separate physical networks or different virtual local area networks (VLANs) on the same physical network.

Each of hosts 105 may be constructed on a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 into multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like.

Hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine. Although aspects of the disclosure are described with reference to VMs, the teachings herein also apply to other types of virtual computing instances (VCIs) or data compute nodes (DCNs), such as containers, which may be referred to as Docker containers, isolated user space instances, namespace containers, etc. In certain embodiments, VCIs 135 may be replaced with containers that run on host 105 without the use of a hypervisor.

Gateway 134 provides VCIs 135 and other components in data center 130 with connectivity to network 110, and is used to communicate with destinations external to data center 130 (not shown). Gateway 134 may be a virtual computing instance, a physical device, or a software module running within host 105.

Controller 136 generally represents a control plane (e.g., “central control plane” for data center 130) that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs, containers, logical switches, logical ports, logical routers, and/or the like) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user.

Database nodes 140 include a plurality of nodes of a hierarchical database that allows for efficient distribution of configuration information, such as logical and/or physical configuration information, from controller 136 to hosts 105 as described herein. The hierarchical database may be implemented in a distributed manner across one or more computing devices, such as running in a plurality of VCIs 135 and/or on or more computing devices separate from host(s) 105 (e.g., on one or more cloud servers). Each database node 140 may store information about a plurality of entities that are managed by manager 138, such as logical switches, logical routers, logical ports, VMs, containers, and/or the like. For example, a given database node 140 may store an identifier of a logical entity in association with configuration information for the logical entity and span information for the logical entity as applicable to that database node 140, as described in more detail below with respect to FIG. 3. Each respective host 105 may have a database node 140 thereon that serves as a respective leaf node in a hierarchical tree of database nodes 140 between controller 136 and host(s) 105. The hierarchical database may be implemented using a variety of different types of database platforms, two examples of which are the Open Virtual Switch (vSwitch) Database Management Protocol (OVSDB) and NestDB.

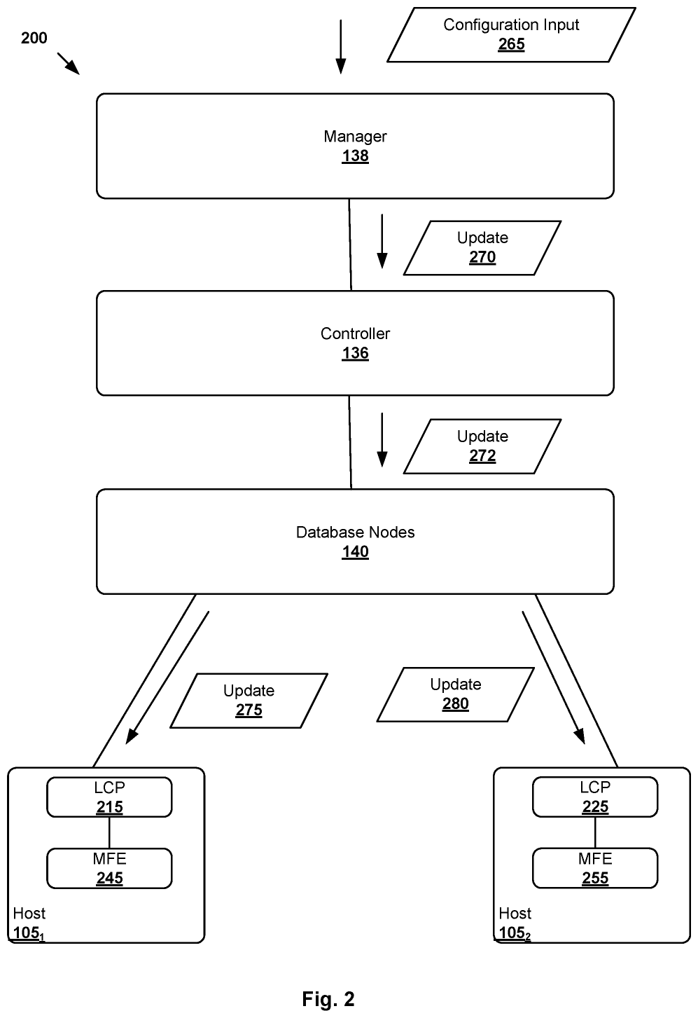

Controller 136 may distribute configuration information to host(s) 105 via database nodes 140, as described below with respect to FIGS. 2-5.

FIG. 2 is a block diagram of a network control system 200, including a manager 138, controller 136, database nodes 140, and hosts 105 of FIG. 1, that implements embodiments described herein. As shown, network control system 200 includes local control planes (LCPs) 215 and 225, also referred to as “local controllers,” that respectively operate on hosts 105₁ and 105₂. In addition, each of hosts 105₁ and 105₂ includes a managed forwarding element (MFE) 245 and 255 that processes data traffic according to configuration information received from their respective local controllers 215 and 225.

Though shown as single entities, it should be understood that both manager 138 and controller 136 may be implemented as distributed or clustered systems. That is, the management plane may include multiple computing devices that implement management plane functions, and a central control plane may include multiple central controller computers or virtual machines or containers or other logical compute instances that implement central control plane functions. In some embodiments, each centralized controller includes both management plane and central control plane functions (e.g., as separate applications or functions).

In some embodiments, manager 138 is responsible for receiving logical network configuration inputs 265 through an application programming interface. Alternatively, users (e.g., network administrators) may input logical network configuration data through, e.g., a command-line interface, a graphical user interface, etc. Each logical network configuration for each logical network, in some embodiments, may include data defining one or more logical forwarding elements, such as logical switches, logical routers, etc. This configuration data may include information describing the logical ports (e.g., assigning media access control (MAC) and/or Internet protocol (IP) addresses to logical ports) for these logical forwarding elements, how the logical forwarding elements interconnect, various service rules (such as distributed firewall rules), etc. Each of these pieces of configuration data, including logical forwarding elements, logical ports, service rules, rule sets, etc., may be referred to as a logical entity.

Manager 138 receives logical network configuration input 265 and generates desired state data for one or more logical networks that should be realized in the physical infrastructure. This data includes a description of the logical forwarding elements and logical ports in a uniform format (e.g., as a set of database records or another format). When users provide configuration changes (e.g., creating or deleting logical entities, modifying properties of logical entities, changing relationships between logical entities, defining and modifying grouping objects, etc.), the changes to the desired state are distributed as logical network updates 270 to controller 136.

Controller 136 receives updates 270 from manager 138, and is responsible for distributing updates to hosts 105₁, 105₂, that it manages. More specifically, updates 270 are communicated to LCPs 215 and 225. Based on the updated configuration information, LCPs 215, 225 convert that configuration update into modifications to forwarding tables, routing tables, VTEP, and other tables or data structures thus modifying the behavior of the managed forwarding elements, routers, and tunnel endpoints, in addition to other logical network devices such as distributed firewalls or load balancers, etc., to realize the logical entity according to its intended state. In some embodiments, controller 136 is part of a central control plane cluster, with each controller in the cluster managing a different set of hosts or logical entities depending on how configuration data is sharded across the CCP cluster. Implementing a central control plane as a cluster, as well as various sharding techniques for distributing data by a clustered central control plane, is described in more detail in U.S. Pat. No. 10,447,535, the contents of which are incorporated herein by reference in their entirety.

Controller 136 receives update 270 to the desired state and, determines the logical entities in the logical network that need to be updated based on update 270. Controller 136 then generates one or more state updates (e.g., update 272) based on update 270 for the local controllers of the corresponding hosts in a span of each logical entity to be updated. For example, controller 136 may determine that MFEs 245 and 255 need to be updated with a configuration change for a particular entity, such as a logical switch.

In some embodiments, controller 136 maintains topological and/or configuration information for the data center, such as comprising a directed graph, and uses this information to determine the span of a given logical entity. Existing techniques for determining a span (e.g., a set of hosts) that are impacted by a configuration change are described in more detail in U.S. Pat. No. 10,742,509, the contents of which are incorporated herein by reference in their entirety.

A hierarchical database comprising a plurality of database nodes 140 is used to efficiently distribute configuration information to applicable hosts without requiring controller 136 to directly send the configuration information to the hosts, which may be quite numerous. As such, controller 136 sends update 272 to a root database node of the hierarchical database without the need to handle any further aspects of the dissemination process. Update 270 includes one or more state updates to one or more entities, and is also sent with span information for each of the one or more entities. For example, if configuration input 265 changes a logical switch and update 270 includes a corresponding state update to the logical switch, controller 136 may determine a span of the logical switch and send the span of the logical switch along with the state update to the root database node 140. The span of an entity generally indicates the hosts that implement the entity. For example, if the logical switch is implemented via virtual switches on hosts 105₁ and 105₂, with the virtual switches being represented as MFEs 245 and 255, then the span of the logical switch includes hosts 105₁ and 105₂. An example of dissemination of a particular configuration change to a logical switch is described below with respect to FIG. 3.

The root database node 140₁ receives update 272 (FIG. 2) and determines respective subsets of update 272, including subsets of the span information, to send to each of one or more child database nodes 140₂, 140₃ based on which hosts are associated with each child database node. Each child database node 140₂, 140₃ may similarly determine subsets of the updates that it receives from its parent, including subsets of received span information, to send to each of its child database nodes until the leaf database nodes 140₄-140₇ are reached. In other words, updates may be modified by intermediate database nodes by including information only relevant to hosts receiving updated configurations from the child database nodes. For example, referring back to FIG. 2, update 275 may be the portion of update 272 that is applicable to host 105₁ and update 280 may be the portion of update 272 that is applicable to host 105₂. The span information sent with update 275 may include only host 105₁ and the span information sent with update 280 may include only host 105₂, even though the span information sent with update 272 may have included both host 105₁ and host 105₂.

In some embodiments, local controllers 215 and 225 are responsible for translating the received updates into configuration data formatted for their respective MFEs 245 and 255, routers (not shown), tunnel endpoints (not shown), firewalls (not shown), or other networking components (not shown) residing on hosts 105. In some embodiments, the local controller is a daemon that operates in the virtualization software of the host machine, as does the MFE and other networking components. In other embodiments, the local controller, MFEs, and other networking components, may operate within a VM that hosts multiple containers for one or more logical networks. In some such embodiments, a first local controller and MFE operate in the virtualization software on the host machine while a second local controller and MFE operate in the container host VM (or multiple such controllers/MFE operate in multiple container host VMs).

In addition, while in some embodiments all MFEs in the physical infrastructure are of the same type (and thus require data in the same format), in other embodiments the physical infrastructure may include multiple different types of MFEs. For instance, some embodiments include both hosts with kernel virtual machine (KVM) virtualization software with a flow-based MFE and hosts with virtualization software with a feature-based MFE. Such different types of MFEs require different data formats from the local controller. As such, in some embodiments, local controllers 215 and 225 are configured to translate the received updates into the specific format required by their MFEs.

FIG. 3 is a block diagram 300 of an example related to distributing configuration information in a network. Block diagram 300 includes controller 136, database nodes 140, and hosts 105 of FIGS. 1 and 2.

A root database node 140₁ is connected to controller 136 in order to receive configuration information and associated span information from controller 136. For example controller 136 may send all configuration information destined for hosts 105 to root database node 140₁, rather than to the hosts themselves. In alternative embodiments (not shown), there may be a plurality of root database nodes, such as one root database node for each node of a central control plane cluster. In such embodiments, each central control plane node in the cluster may send its configuration information to a corresponding root database node. In some embodiments, all central control plane nodes will determine the same configuration updates (e.g., because they are synchronized with one another for redundancy purposes), and so the data sent to each of a plurality of root database nodes will be identical. In such cases, intermediary database nodes can connect to any root database node and can switch from one root database node to another as needed (e.g., if one root database node goes down or becomes too congested). In certain embodiments, there may be more or fewer root database nodes than central control plane nodes. For example, one central control plane node may send the same data to a plurality of root database nodes, such as for redundancy and/or to avoid overloading a single root database node. In some embodiments, each of a plurality of root database nodes may have its own hierarchy leading down to one or more leaf nodes.

Two child database nodes 140₂ and 140₃ are located beneath root database node 140₁ as child nodes in a hierarchical tree structure. Two leaf database nodes 140₄ and 140₅ are located beneath database node 140₂ as its child nodes and two leaf database nodes 140₆ and 140₇ are located beneath database node 140₃ as its child nodes. Database nodes 140₄₋₇ are leaf nodes because they represent the destination database instances for these hosts that are used to configure these hosts. While database nodes 140₁₋₃ may also incidentally be implemented on one or more hosts 105 in certain embodiments, these database nodes are not leaf nodes because they serve as logically intermediary nodes between controller 136 and the leaf nodes. Intermediary nodes other than the root database node 140₁ may be referred to as branch nodes. It is noted that while the leaf nodes, database nodes 140₄₋₇, are depicted as being located on hosts 105₁₋₄, the leaf nodes do not necessarily need to be located on 105₁₋₄. For example, the leaf nodes may be located separately from hosts 105₁₋₄, and may send the data they receive to the LCPs on hosts 105₁₋₄. It is also not necessary for there to be the same number of leaf nodes as there are hosts. For example, each leaf node may distribute data to more than one host, and may determine a subset of configuration information to send to each host for which it is responsible.

The tree structure of database nodes 140 may be determined in a variety of ways, such as centrally by controller 136 or root database node 140₁, or in a distributed manner by individual database nodes 140. In one example implementation, child database nodes “register” the entities they are interested in with a parent database node, such as indicating the hosts for which they are requesting to receive configuration information from the parent database node. For instance, database node 140₄ may indicate to database node 140₂ that it is interested in receiving configuration information for host 105₁, database node 140₅ may indicate to database node 140₂ that it is interested in receiving configuration information for host 105₂, and database node 140₂ may indicate to database node 140₁ that it is interested in receiving configuration information for hosts 105₁ and 105₂. Parent database nodes may store associations between child database nodes and hosts, either received from the child database nodes or some other source such as controller 136 or root database node 140₁, and these stored associations may be used to determine subsets of received configuration information and subsets of received span information associated with the received configuration information to distribute to particular child database nodes.

It is noted that the configuration information that is distributed via the hierarchical database may include logical configuration information and/or physical configuration information. For example, in some embodiments, logical configuration information is distributed from the central control plane to the LCPs of hosts, and the LCPs determine physical configuration changes to make based on the logical configuration information. In other embodiments, an intermediate data type called “universal physical control plane data” is distributed from the central control plane to the LCPs, and is converted by the LCP into customized physical control plane data for particular hosts, as described in U.S. Pat. No. 9,319,337, the contents of which are incorporated herein by reference in their entirety. Techniques described herein may be used to distribute a variety of types of configuration information from a central control plane and/or a management plane to individual hosts, and references to particular types of configuration information are included as examples. Furthermore, the presence of LCPs on hosts is included as an example of how hosts may receive configuration information that is distributed by a central control plane and/or a management plane, and implementations that do not involve LCPs are also possible.

It is further noted that hosts may send runtime updates to the central control plane, such as via the LCPs on the hosts, and the central control plane may calculate spans for configuration updates based on the runtime updates from the hosts as well as based on the configuration updates themselves. Furthermore, the central control plane may also perform additional operations related to configuration updates received from the management plane, such as translating abstract policies into actual firewall rules that can be understood by hosts (e.g., which may be an example of configuration information that is distributed to the hosts via the hierarchical database).

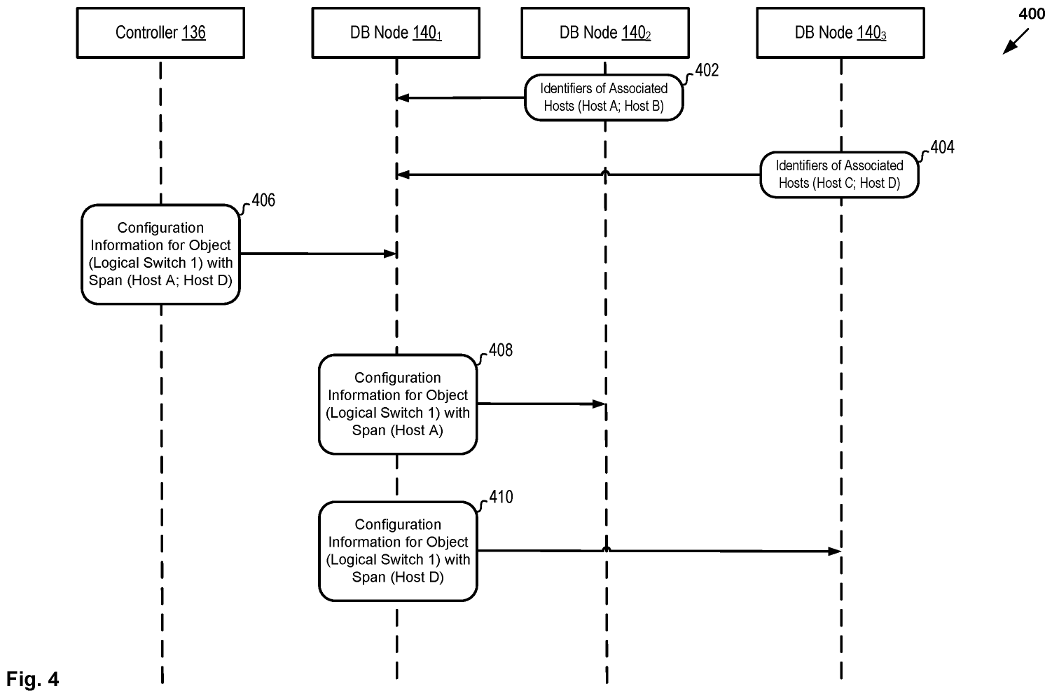

FIG. 4 is an illustration of an example exchange 400 of messages between components related to efficient distribution of configuration information in a network. Exchange 400 includes controller 136 and database nodes 140 of FIGS. 1-3. Database nodes 140₁₋₃ may be arranged in a hierarchical tree structure as shown and described above with respect to FIG. 3.

At block 402, database node 140₂ sends identifiers of associated hosts (hosts A and B, which may refer to hosts 105₁ and 105₂ of FIG. 3) to database node 140₁. For example, block 402 may represent database node 140₂ registering its interest in logical configuration information relating to hosts A and B with a parent database node 140₁.

Similarly, at block 404, database node 140₃ sends identifiers of associated hosts (hosts C and D, which may refer to hosts 105₃ and 105₄ of FIG. 3) to database node 140₁.

In alternative embodiments, database node 140₁ may determine an association between database node 140₂ and hosts A and B and an association between database node 140₃ and hosts C and D based on information from one or more other sources, such as controller 136 (e.g., in implementations where the hierarchical tree structure of the hierarchical database is centrally determined and disseminated).

Database node 140₁ may store an association between database node 140₂ and hosts A and B and an association between database node 140₃ and hosts C and D.

At block 406, controller 136 sends database node 140₁ an update including logical configuration information for a particular object (logical switch 1) and associated span information for the object (host A and host D). For example, an administrator may have provided input via the management plane indicating a configuration change to logical switch 1 (e.g., configuration input 265 of FIG. 2), and controller 136 may have received a corresponding update from the management plane (e.g., update 270 of FIG. 2) and determined a span of logical switch 1 to include hosts A and D. The update sent at block 406 may correspond to update 272 of FIG. 2.

At block 408, database node 140₁ sends logical configuration information for the object (logical switch 1) with span information indicating a span of host A to its child database node 140₂. For example, database node 140₁ may have determined a subset of the information it received at block 406 to send to its child database node 140₂ based on a stored association between database node 140₂ and hosts A and B (e.g., based on information received by database node 140₁ at block 402). Thus, because database node 140₂ is interested in receiving information about host A and is not interested in receiving information about host D, database node 140₁ sends database node 140₂ only the portion of the logical configuration information that relates to host A (which may or may not be the entirety of the logical configuration information received at block 406) and only the portion of the span information that is associated with database node 140₂, which in this case includes only host A.

Similarly, at block 410, database node 140₁ sends logical configuration information for the object (logical switch 1) with span information indicating a span of host D to its child database node 140₃. For example, database node 140₁ may have determined a subset of the information it received at block 406 to send to its child database node 140₃ based on a stored association between database node 140₃ and hosts C and D (e.g., based on information received by database node 140₁ at block 404). Thus, because database node 140₃ is interested in receiving information about host D and is not interested in receiving information about host A, database node 140₁ sends database node 140₃ only the portion of the logical configuration information that relates to host D (which may or may not be the entirety of the logical configuration information received at block 406) and only the portion of the span information that is associated with database node 140₃, which in this case includes only host D.

Database nodes 140₂ and 140₃ in turn distribute subsets of the logical configuration information and span information that they receive to their respective child database nodes based on stored associations between those respective child database nodes and certain hosts. For example, with reference to FIG. 3, database node 140₂ may send the logical configuration information for logical switch 1 to database node 140₄ on host 105₁ (e.g., host A) and database node 140₃ may send the logical configuration information for logical switch 1 to database node 140₇ on host 105₄ (e.g., host D).

It is noted that the tree structure depicted in FIG. 3 is only included as an example, and many other types of tree structures may also or alternatively be used. For example, it may be advantageous to utilize a larger number of database nodes 140 arranged in multiple hierarchical levels in order to further distribute load related to distributing logical configuration information to hosts, particularly in cases where a large number of hosts are involved. For example, a hierarchical database as described herein may be scaled in a manner that is appropriate to the computing environment in which it is deployed, such as based on numbers of hosts, amounts of computing resources available, geographic locations of hosts, and/or the like.

In some cases, a plurality of logical configuration changes are closely related to one another, such as resulting from a single underlying configuration change input via the management plane, and are processed together in the form of a transaction. For example, a change to a configuration of a logical switch may result in changes to multiple logical ports of the logical switch, and it may be desirable to process the changes to the logical switch and all of the logical ports together as a single transaction. In such cases, controller 136 may send the transaction with all of the corresponding logical configuration changes and associated span information for all updated logical entities to root database node 140₁. Root database node 140₁ may then generate a new respective transaction send to each of its respective child nodes (e.g., database nodes 140₂ and 140₃) comprising a subset of the transaction that is relevant to the respective child node as well as a subset of the span information that is relevant to the respective child node. For example, the logical switch object may be sent to all hosts in its span, while the logical port objects may only be sent towards the hosts on which those individual logical ports are implemented, which may be subsets of the total span of the logical switch. Thus, related logical configuration changes can be processed together when received at leaf nodes as appropriate.

For example, with reference to FIG. 3, controller 136 may send a transaction to database node 140₁ with updates to three objects: object a (e.g., a logical switch) with a span of hosts A and C; object b (a logical port of the logical switch) with a span of host A; and object c (another logical port of the logical switch) with a span of host C. Database node 140₁ may generate a transaction to send to its child database node 140₂ containing object a with a span of host A and object b with a span of host A. Similarly, database node 140₁ may generate a different transaction to send to its child database node 140₃ containing object a with a span of host C and object c with a span of host C. It is noted that an “object” may comprise the logical configuration information for the corresponding logical entity.

In some cases, a host and/or database node may go offline, such as due to a failure or loss of connection. When such a host or database node comes back online its state will need to be resynchronized with the current logical configuration state of the data center. Similarly, new hosts and/or database nodes may be added to the data center or may connect to new parent database node over time, and may need to be synchronized with the current logical configuration state of the data center. Existing techniques for synchronizing a host involve the control plane sending the host all of the logical configuration information that is relevant to the host, which may involve a substantial amount of load on the control plane and becomes particularly inefficient in large computing environments where such disconnection, re-connections, and/or additions of hosts are common. As such, techniques described herein allow a database node to be efficiently synchronized, after a disconnection and re-connection or upon establishing a new connection, through interaction with a parent database node.

In some embodiments, upon determining a need to synchronize (e.g., after going offline and coming back online, upon being added to the data center, or upon identifying a new parent database node) a database node 140 sends a synchronization request to its parent database node 140, and the parent database node 140 sends the database node 140 all logical configuration and associated span information that is relevant to the database node 140 in response to the synchronization request. In some embodiments that parent database node 140 freezes its own state while handling a synchronization request from a child database node 140, avoids sending any changes from uncommitted transactions, and calculates a single transaction that includes all objects and associated spans that are in the interest list of the child database node 140 (e.g., based on a stored association between the child database node 140 and one or more hosts and/or based on information provided by the child database node 140 or another entity). The child database node 140 may replace all previously stored data (if any such data exists) with the newly received data, such as deleting existing data and applying the received transaction.

In other embodiments, in order to further improve efficiency, version numbers may be distributed and stored with logical configuration information for each logical entity. For example, each subsequent configuration change to a given logical entity at the root database node 140 may be associated with a version number, and whenever a database node 140 updates its stored data for the logical entity based on that configuration change it may store that version number in association with the logical entity (e.g., version numbers may be sent along with logical configuration information and span information from parent database nodes to child database nodes). Version numbers may be incremented with any change to logical configuration information as well as with any change to span information. These version numbers may be used to perform a more efficient synchronization between a child database node 140 and a parent database node 140. For example, the child database node 140 may send the parent database node 140 the logical entities it is interested in (e.g., the keys for the key-value store) and the version number for any information that the child database node 140 currently stores (if any) for each of the logical entities. The parent database node 140 may compare the version numbers received from the child database node 140 to its own stored version numbers for each of the logical entities, and may send the child database node 140 the logical configuration information and associated span information for a given requested logical entity only if the parent database node 140 stores a later version for that requested entity than the child database node 140. If the parent database node 140 does not have any data for a given requested logical entity, the parent database node 140 may send a request for the data to its parent database node 140, and so on, until some database node 140 is able to provide the requested data for distribution back through the hierarchical chain to the requesting child database node 140.

In alternative embodiment, the parent database node 140 sends the child database node 140 the logical entities it stores information about (e.g., the keys for the key-value store) and the version number for information that the parent database node 140 stores for each of the logical entities. The child database node 140 may then compare the version numbers received from the parent to its own version numbers to determine which information to request from the parent database node 140.

Version numbers may be globally unique across the hierarchical database, and may prevent cases where a child node that is more up to date than a parent node to which it connects would otherwise be “updated” based on the outdated information stored at the parent node.

In order to further enhance the performance for the synchronization case, some embodiments involve maintaining a reverse index table for each host at each database node 140. The reverse index table for a host only stores an object key and its version if the host appears in its span in order to keep the footprint of such table small. The reverse index tables will always be updated as appropriate when a transaction is processed. When a synchronization request is received by a parent database node along with the child's interest list and all its local object key to version pairs, the parent database node may merge the reverse index tables whose hosts appeared in the child's interest list. Then the parent database node may generate a desired synchronization object key to version list and compare it with the child's object key to version list to find out which objects were created, changed or deleted since the child's data was last updated. This technique may further reduce computing resource utilization and improve efficiency, particular in cases where a child database node is suffering from a network flapping problem and frequently triggers full synchronization requests to its parent.

If a database node 140 goes offline, its child database nodes 140 may connect to a new parent database node 140 and perform a synchronization process as described above. Thus, techniques described herein provide high availability and efficiency even as database nodes lose connections, re-connect, and/or establish new connections between one another. By utilizing version numbers so that a parent database node 140 only sends a child database node 140 relevant information for which the parent database node 140 has a later version than the child database node 140, techniques described herein reduce the amount of computing resources and time required to perform a synchronization operation, and thereby further improve the functioning of the system.

In some cases, it may be advantageous to arrange a tree structure of database nodes 140 in such a manner as to provide redundancy for the purposes of fault tolerance. For example, in database node or network failure cases, a leaf node or a branch node that lost its parent node should choose another node as its new parent. However, the new parent node may not have enough “view” (e.g., data for relevant logical entities) for the child node yet, and the new parent node may need to update its own interest list on its own parent node. This process may recur multiple times in a bottom up manner until the parent node can ultimately fulfil the necessary update. This process may be time consuming, and so it may be advantageous to include certain database nodes, such as agents and proxies, that register with additional parent database nodes to which they would not otherwise connect and/or register additional logical entities that would not otherwise be in their interest list for redundancy purposes. In some embodiments, certain database nodes 140 may serve as alternate parent nodes to particular child database nodes 140, such as requesting all of the data from those particular child database nodes' interest lists from the current parent node of those child database nodes and storing the data for use in the event of the parent. In one example, proxy or agent database nodes 140 can listen for changes from parent nodes and/or for logical entities to which they are not otherwise related so that these proxy or agent database nodes 140 are ready to serve as alternate parent nodes in the event of a failure. In some cases, a database node 140 serving as a proxy or agent may notify the child database nodes for which it serving as an alternate parent of its status as an alternate parent, or may notify root database node 140₁, controller 136, or some other central entity that it is serving as an alternate for one or more particular database nodes 140 and/or for one or more particular logical entities. Child database nodes 140 in search of a new parent may use notifications received from alternate parents to select such alternate parents, and/or may communicate with root database node 140, controller 136, or some other central entity to determine which database node 140 it should connect to as its new parent. Alternatively, child database nodes 140 may determine which new parent node to connect to without consulting any central entity or receiving any notification from alternate parents, such as relying on random selection or some other process, and the redundancy provided by proxy or agent nodes may still help the needed data get to the child database node 140 more efficiently due to the multiplicity of avenues for obtaining data provided by such redundancy.

One or more redundant root database nodes may also be included for fault tolerance purposes. In some cases, if the control plane is implemented as a plurality of redundant nodes where only one control plane node is performing span calculations at a given time and the other control plane nodes are in standby mode (e.g., active-standby mode), the state of a primary root database node 140₁ will be replicated to all redundant root database nodes 140 and, when an error occurs with respect to the primary root database node 140₁, a redundant root database node 140 can take over as the primary root database node.

In implementations where the control plane includes a plurality of active control plane nodes (e.g., active-active mode), where all of the control plane nodes calculate configuration information and span information separately and simultaneously based on a deterministic finite state machine (DFSM), each control plane node can have a separate root database node because the control plane nodes will generate exactly the same configuration transaction sequence and span information. For example, each control plane node may send its updates to its own corresponding root database node, and all of these root database nodes will store identical data. In such cases, all of the root database nodes can form a logical or virtual root node even though they do not synchronize their states with one another, and other database nodes that connect directly to the root database node can choose any of the different root database nodes as its parent, switching in the event of failure.

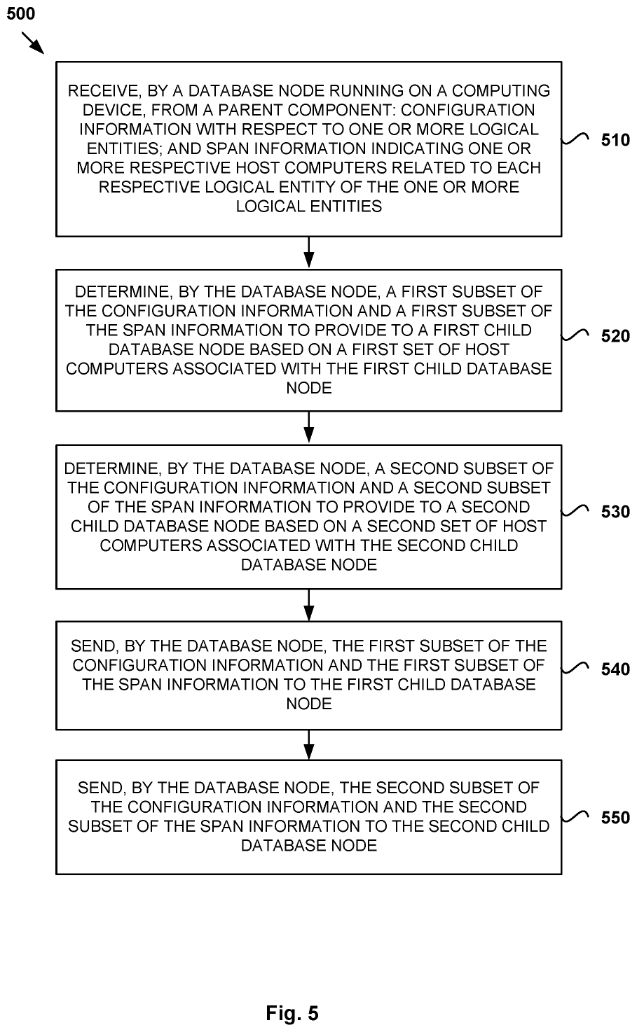

FIG. 5 illustrates example operations 500 related to efficiently distributing logical configuration information in a network. For example, operations 500 may be performed by database node(s) 140, controller 136, and/or one or more other components of data center 130 of FIG. 1.

Operations 500 begin at step 510, with receiving, by a database node running on a computing device, from a parent component: logical configuration information with respect to one or more logical entities; and span information indicating one or more respective host computers related to each respective logical entity of the one or more logical entities.

Operations 500 continue at step 520, with determining, by the database node, a first subset of the logical configuration information and a first subset of the span information to provide to a first child database node based on a first set of host computers associated with the first child database node.

Some embodiments further comprise determining, by the database node, that the first set of host computers is associated with the first child database node based on receiving identifiers corresponding to the first set of host computers from the first child database node.

Operations 500 continue at step 530, with determining, by the database node, a second subset of the logical configuration information and a second subset of the span information to provide to a second child database node based on a second set of host computers associated with the second child database node.

In some embodiments, the first subset of the logical configuration information and the first subset of the span information are different from the second subset of the logical configuration information and the second subset of the span information.

Operations 500 continue at step 540, with sending, by the database node, the first subset of the logical configuration information and the first subset of the span information to the first child database node.

Operations 500 continue at step 550, with sending, by the database node, the second subset of the logical configuration information and the second subset of the span information to the second child database node.

In certain embodiments, the logical configuration information is received from the parent component as a transaction that includes a plurality of logical configuration changes, and the database node sends the first subset of the logical configuration information to the first child database node as a first transaction, and wherein the database node sends the second subset of the logical configuration information to the second child database node as a second transaction.

Some embodiments further comprise receiving, by the database node, a connection from a third child database node and sending, by the database node, a transaction to the third child database node, the transaction comprising a set of logical configuration information and associated span information that is determined based on a third set of host computers associated with the third child database node. For example, the third child database node may delete its local data corresponding to the third set of host computers and store the set of logical configuration information and associated span information.

In some embodiments, the database node further receives, from the third child database node, a set of database keys with associated version numbers indicating versions of local values stored by the third child database node in association with the set of database keys, and the database node determines the set of logical configuration information and associated span information based further on the set of database keys and the associated version numbers. In an example, the database node excludes from the set of logical configuration information and associated span information any data for which the database node determines, based on the set of database keys and the associated version numbers, that the third child database node is already up to date.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), optical media such as DVD (Digital Versatile Disc), and magnetic media such as magnetic tape. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims. Note that some explanations herein may reflect a common interpretation or abstraction of actual processing mechanisms. Some descriptions may therefore abstract away complexity and explain higher level operations without burdening the reader with unnecessary technical details of well understood mechanisms. Such abstractions in the descriptions herein should be construed as inclusive of the well understood mechanisms.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for distributing configuration information in a network, the method comprising:
receiving, by a database node running on a computing device, from a parent component:
configuration information with respect to one or more logical entities; and
span information indicating one or more respective host computers related to each respective logical entity of the one or more logical entities;
determining, by the database node, a first subset of the configuration information and a first subset of the span information to provide to a first child database node based on a first set of host computers associated with the first child database node;
determining, by the database node, a second subset of the configuration information and a second subset of the span information to provide to a second child database node based on a second set of host computers associated with the second child database node;
sending, by the database node, the first subset of the configuration information and the first subset of the span information to the first child database node; and
sending, by the database node, the second subset of the configuration information and the second subset of the span information to the second child database node.

2. The method of claim 1, wherein the first subset of the configuration information and the first subset of the span information are different from the second subset of the configuration information and the second subset of the span information.

3. The method of claim 1, further comprising determining, by the database node, that the first set of host computers is associated with the first child database node based on receiving identifiers corresponding to the first set of host computers from the first child database node.

4. The method of claim 1, wherein the configuration information is received from the parent component as a transaction that includes a plurality of configuration changes, wherein the database node sends the first subset of the configuration information to the first child database node as a first transaction, and wherein the database node sends the second subset of the configuration information to the second child database node as a second transaction.

5. The method of claim 1, further comprising:
receiving, by the database node, a connection from a third child database node; and
sending, by the database node, a transaction to the third child database node, wherein the transaction comprises a set of configuration information and associated span information that is determined based on a third set of host computers associated with the third child database node.

6. The method of claim 5, wherein the third child database node deletes its local data corresponding to the third set of host computers and stores the set of configuration information and associated span information.

7. The method of claim 5, wherein the database node further receives, from the third child database node, a set of database keys with associated version numbers indicating versions of local values stored by the third child database node in association with the set of database keys, and wherein the database node determines the set of configuration information and associated span information based further on the set of database keys and the associated version numbers.

8. The method of claim 7, wherein the database node excludes from the set of configuration information and associated span information any data for which the database node determines, based on the set of database keys and the associated version numbers, that the third child database node is already up to date.

9. A system for distributing configuration information in a network, comprising:
at least one memory; and
at least one processor coupled to the at least one memory, the at least one processor and the at least one memory configured to:
receive, by a database node running on a computing device, from a parent component:
configuration information with respect to one or more logical entities; and
span information indicating one or more respective host computers related to each respective logical entity of the one or more logical entities;
determine, by the database node, a first subset of the configuration information and a first subset of the span information to provide to a first child database node based on a first set of host computers associated with the first child database node;
determine, by the database node, a second subset of the configuration information and a second subset of the span information to provide to a second child database node based on a second set of host computers associated with the second child database node;
send, by the database node, the first subset of the configuration information and the first subset of the span information to the first child database node; and
send, by the database node, the second subset of the configuration information and the second subset of the span information to the second child database node.

10. The system of claim 9, wherein the first subset of the configuration information and the first subset of the span information are different from the second subset of the configuration information and the second subset of the span information.

11. The system of claim 9, wherein the at least one processor and the at least one memory are further configured to determine, by the database node, that the first set of host computers is associated with the first child database node based on receiving identifiers corresponding to the first set of host computers from the first child database node.

12. The system of claim 9, wherein the configuration information is received from the parent component as a transaction that includes a plurality of configuration changes, wherein the database node sends the first subset of the configuration information to the first child database node as a first transaction, and wherein the database node sends the second subset of the configuration information to the second child database node as a second transaction.

13. The system of claim 9, wherein the at least one processor and the at least one memory are further configured to:
receiving, by the database node, a connection from a third child database node; and
sending, by the database node, a transaction to the third child database node, wherein the transaction comprises a set of configuration information and associated span information that is determined based on a third set of host computers associated with the third child database node.

14. The system of claim 13, wherein the third child database node deletes its local data corresponding to the third set of host computers and stores the set of configuration information and associated span information.

15. The system of claim 13, wherein the database node further receives, from the third child database node, a set of database keys with associated version numbers indicating versions of local values stored by the third child database node in association with the set of database keys, and wherein the database node determines the set of configuration information and associated span information based further on the set of database keys and the associated version numbers.

16. The system of claim 15, wherein the database node excludes from the set of configuration information and associated span information any data for which the database node determines, based on the set of database keys and the associated version numbers, that the third child database node is already up to date.

17. A non-transitory computer readable medium storing instructions that, when executed by one or more processors, cause the one or more processors to:
receive, by a database node running on a computing device, from a parent component:
configuration information with respect to one or more logical entities; and
span information indicating one or more respective host computers related to each respective logical entity of the one or more logical entities;
determine, by the database node, a first subset of the configuration information and a first subset of the span information to provide to a first child database node based on a first set of host computers associated with the first child database node;
determine, by the database node, a second subset of the configuration information and a second subset of the span information to provide to a second child database node based on a second set of host computers associated with the second child database node;
send, by the database node, the first subset of the configuration information and the first subset of the span information to the first child database node; and
send, by the database node, the second subset of the configuration information and the second subset of the span information to the second child database node.

18. The non-transitory computer readable medium of claim 17, wherein the first subset of the configuration information and the first subset of the span information are different from the second subset of the configuration information and the second subset of the span information.

19. The non-transitory computer readable medium of claim 17, wherein the instructions, when executed by the one or more processors, cause the one or more processors to determine, by the database node, that the first set of host computers is associated with the first child database node based on receiving identifiers corresponding to the first set of host computers from the first child database node.

20. The non-transitory computer readable medium of claim 17, wherein the configuration information is received from the parent component as a transaction that includes a plurality of configuration changes, wherein the database node sends the first subset of the configuration information to the first child database node as a first transaction, and wherein the database node sends the second subset of the configuration information to the second child database node as a second transaction.
